(19) United States
(12) Patent Application Publication
(10) Pub. No.: US 2026/0220611 A1
(43) Pub. Date: Jul. 30, 2026

(54) Configurable and Performant Events

(71) Applicant: ServiceNow, Inc., Santa Clara, CA (US)

(72) Inventors: Rohan Hemachandra Rasane, San Jose, CA (US); Corey Leamon, Escondido, CA (US); Rafael Lagares Vale, San Diego, CA (US); Justin denBroeder, San Diego, CA (US); Alonzo Castanon, El Cajon, CA (US)

(21) Appl. No.: 19/037,977

(22) Filed: Jan. 27, 2025

(51) Int. Cl. G06Q 10/1093; G06F 9/50; G06F 16/955; H04L 67/02

(52) U.S. Cl. CPC G06Q 10/1093; G06F 9/5027; G06F 16/955; H04L 67/02; G06F 2209/5022; G06F 2209/503

(57) ABSTRACT

A method for configurable events includes obtaining a first request to schedule a first event that includes a first number of attendees. The method includes determining that the first number of attendees satisfies a threshold and, based on determining that the first number of attendees satisfies the threshold, generating a first webpage for hosting the first event. The first webpage, when visited, generates a first number of server calls. The method includes obtaining a second request to schedule a second event that includes a second number of attendees. The method includes determining that the second number of attendees fails to satisfy the threshold and, based on determining that the second number of attendees fails to satisfy the threshold, generating a second webpage for hosting the second event. The second webpage, when visited, generates a second number of server calls that is less than the first number of server calls.

### TECHNICAL FIELD

This disclosure relates to configurable and/or performant events.

### BACKGROUND

Managing high-traffic events on content publishing platforms is a critical task for organizations that rely on these platforms for their operations. High-traffic events, such as company-wide meetings or product launches, often result in a large number of users accessing the platform simultaneously. This surge in traffic can overwhelm the system, leading to crashes, slow performance, and a poor user experience. To mitigate these risks, organizations typically employ various tools and techniques to manage the load on their content publishing platforms. However, existing methods and systems for load management face several challenges that limit their performance and effectiveness. These challenges include the inability to dynamically adjust system properties based on current resources and the lack of mechanisms to differentiate between normal and surge events

### SUMMARY

One aspect of the disclosure provides a method for configurable events. The computer-implemented method includes obtaining a first request to schedule a first event. The first request includes a first number of attendees invited to the first event. The method includes determining that the first number of attendees satisfies a threshold.

Based on determining that the first number of attendees satisfies the threshold, the method includes generating a first webpage for hosting the first event. The first webpage, when visited, generates a first number of server calls to a server. The method includes obtaining a second request to schedule a second event. The second request includes a second number of attendees invited to the second event. The method includes determining that the second number of attendees fails to satisfy the threshold. Based on determining that the second number of attendees fails to satisfy the threshold, the method includes generating a second webpage for hosting the second event. The second webpage, when visited, generates a second number of server calls to the server, and the second number of server calls is less than the first number of server calls.

Implementations of the disclosure may include one or more of the following optional features. In some implementations, the threshold is static. Optionally, the method further includes determining an amount of computing resources available to the server and adjusting the threshold based on the determined amount of computing resources available to the server.

In some examples, the first webpage includes a first menu bar that loads a first amount of dynamic data from the server and the second webpage includes a second menu bar that loads a second amount of dynamic data from the server. The second amount of dynamic data is less than the first amount of dynamic data. The first webpage may not use lazy loading while the second webpage may use lazy loading.

In some implementations, the method includes generating a first link that directs users to the first webpage, generating a second link that directs attendees to the second webpage, and distributing the first link and the second link to the attendees invited to the first event and the second event. The method may include obtaining a third request to visit the first webpage, determining that a user associated with the third request is associated with the second event, and prior to loading the first webpage, directing the user to the second webpage. In some of these examples, directing the user to the second webpage includes generating a pop-up notification.

In some examples, determining that the first number of attendees satisfies the threshold includes determining that the first number of attendees is less than the threshold and determining that the second number of attendees fails to satisfy the threshold includes determining that the second number of attendees is greater than or equal to the threshold. In some implementations, the first webpage and the second webpage are each associated with an employee portal. Generating the second webpage may include embedding a video stream to reduce server calls to the server.

Another aspect of the disclosure provides a system for configuring events. The system includes data processing hardware and memory hardware in communication with the data processing hardware. The memory hardware stores instructions that when executed on the data processing hardware cause the data processing hardware to perform operations. The operations include obtaining a first request to schedule a first event. The first request includes a first number of attendees invited to the first event. The operations include determining that the first number of attendees satisfies a threshold. Based on determining that the first number of attendees satisfies the threshold, the operations include generating a first webpage for hosting the first event. The first webpage, when visited, generates a first number of server calls to a server. The operations include obtaining a second request to schedule a second event. The second request includes a second number of attendees invited to the second event. The operations include determining that the second number of attendees fails to satisfy the threshold. Based on determining that the second number of attendees fails to satisfy the threshold, the operations include generating a second webpage for hosting the second event. The second webpage, when visited, generates a second number of server calls to the server, and the second number of server calls is less than the first number of server calls.

This aspect may include one or more of the following optional features. Optionally, the method further includes determining an amount of computing resources available to the server and adjusting the threshold based on the determined amount of computing resources available to the server.

In some examples, the first webpage includes a first menu bar that loads a first amount of dynamic data from the server and the second webpage includes a second menu bar that loads a second amount of dynamic data from the server. The second amount of dynamic data is less than the first amount of dynamic data. The first webpage may not use lazy loading while the second webpage may use lazy loading.

In some implementations, the method includes generating a first link that directs users to the first webpage, generating a second link that directs attendees to the second webpage, and distributing the first link and the second link to the attendees invited to the first event and the second event. The method may include obtaining a third request to visit the first webpage, determining that a user associated with the third request is associated with the second event, and prior to loading the first webpage, directing the user to the second webpage. In some of these examples, directing the user to the second webpage includes generating a pop-up notification.

In some examples, determining that the first number of attendees satisfies the threshold includes determining that the first number of attendees is less than the threshold and determining that the second number of attendees fails to satisfy the threshold includes determining that the second number of attendees is greater than or equal to the threshold. In some implementations, the first webpage and the second webpage are each associated with an employee portal. Generating the second webpage may include embedding a video stream to reduce server calls to the server.

Another aspect of the disclosure provides a computer-readable medium having instructions that, when executed by data processing hardware, causes the data processing hardware to perform operations. The operations include obtaining a first request to schedule a first event. The first request includes a first number of attendees invited to the first event. The operations include determining that the first number of attendees satisfies a threshold. Based on determining that the first number of attendees satisfies the threshold, the operations include generating a first webpage for hosting the first event. The first webpage, when visited, generates a first number of server calls to a server. The operations include obtaining a second request to schedule a second event. The second request includes a second number of attendees invited to the second event. The operations include determining that the second number of attendees fails to satisfy the threshold. Based on determining that the second number of attendees fails to satisfy the threshold, the operations include generating a second webpage for hosting the second event. The second webpage, when visited, generates a second number of server calls to the server, and the second number of server calls is less than the first number of server calls.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for an example system for configuring events.

FIG. 2A is a schematic view of an example webpage hosting a non-surge event.

FIG. 2B is a schematic view of an example webpage hosting a surge event.

FIG. 3 is a flowchart of an example arrangement of operations for a method of configuring events.

FIG. 4 is a schematic view of an example computing device that may be used to implement the systems and methods described herein.

Like reference symbols in the various drawings indicate like elements.

### DETAILED DESCRIPTION

The field of load management for content publishing platforms involves ensuring the stability and responsiveness of the system during high-traffic events. These events represent periods of increased user activity that can overwhelm the system, leading to crashes and degraded performance. Effective load management is vital for maintaining a reliable platform and providing a positive user experience. However, existing methods and systems for load management face several challenges that limit their performance and effectiveness.

For example, conventional methods for managing high-traffic events often rely on static configurations that do not account for the dynamic nature of user activity. These methods may not be able to handle sudden surges in traffic, leading to system crashes and slow performance. Moreover, these methods may not provide mechanisms for content creators to schedule and target specific content for high-traffic events, resulting in inefficient use of system resources.

Another challenge is the lack of mechanisms to differentiate between normal and surge events. High-traffic events require different handling compared to regular events to ensure system stability. Without the ability to dynamically adjust system properties based on current resources and user activity, the system may become overloaded during surge events, leading to crashes and a poor user experience.

Implementations herein provide an event manager for managing high-traffic events on content publishing platforms that overcomes these challenges. The event manager obtains a request to schedule an event that includes a number of attendees invited to the event. The event manager may determine whether the number of attendees satisfies a threshold. When the number of attendees does satisfy the threshold, the event manager may generate a first webpage for hosting the event that, when visited, generates a first number of server calls to a server. When the number of attendees does not satisfy the threshold, the event manager may generate a second webpage for hosting the event that, when visited, generates a second number of server calls to the server that is less than the first number of server calls.

Thus, the event manager may generate dedicated event pages for high-traffic events, which have, for example, reduced menu bars and minimal processing requirements to significantly reduce the load on the system (e.g., by reducing a number of server calls to load or retrieve dynamic data). This ensures that the system remains stable and responsive even when a large number of users access it simultaneously. Additionally, the event manager allows content creators to schedule specific content for an event and target it to a particular audience, enhancing the efficiency of content delivery.

The event manager may direct users to the event page via a direct link, for example sent through an email blast. In some implementations, the event manager includes logic to redirect users who log into the employee center during a high-traffic event to the event page (e.g., the first webpage), for example through a popup notification. This ensures that users can easily access the event without overwhelming the system even when the users do not use a direct link to the dedicated webpage (i.e., the second webpage).

The event manager offers advantages over existing methods and systems for load management. For example, the event manager may automate the process of generating dedicated event pages, reducing manual work and resource wastage. Additionally, the accuracy and relevance of the content delivery are enhanced by allowing content creators to schedule and target specific content for high-traffic events. Moreover, the event manager may improve the efficiency and stability of the content publishing platform by dynamically adjusting and/or generating webpages or other content based on various factors (i.e., current resources, an event type, user activity), ensuring a positive user experience even during high-traffic events.

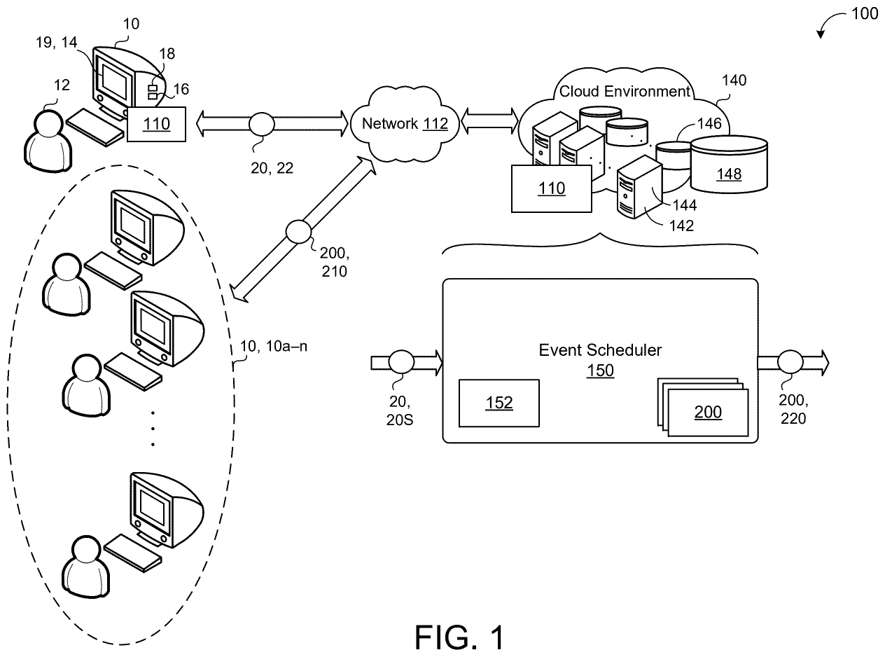

Referring now to FIG. 1, in implementations, a system 100 for managing high-traffic events 20, 20S includes a remote system 140 in communication with one or more user devices 10, 10a-n via one or more networks 112. The network(s) 112 may be any type of network, such as the Internet, a local area network (LAN), a wide area network (WAN), a cellular network, or a wireless network. The remote system 140 may be a single computer, multiple computers, or a distributed system (e.g., a cloud environment) having scalable or elastic resources 142, including computing resources 144 (e.g., data processing hardware) and/or storage resources 146 (e.g., memory hardware). A data store 148 may be overlain on the storage resources 146 to allow scalable use of the storage resources 146 by one or more of the clients (e.g., the user device 10) or the computing resources 144.

The remote system 140 may execute an event scheduler 150 that communicates with the user device 10 via the network 112. The event scheduler 150 may be a software application or module that is configured to manage high-traffic events 20S using a content publishing application 110 or the like. In this context, an event 20 refers to a scheduled activity or gathering where many or most of the attendees are expected to join or view simultaneously, such as a live event. Examples of events covered by the invention include company-wide meetings, product launches, training sessions, and other high-traffic events that require robust content delivery and system stability.

The event scheduler 150 may interact with other software applications or modules that provide the content publishing application 110 or the content for the events 20, such as a web browser, a web server, a web application, a native application, or a hybrid application. The event scheduler 150 may receive requests to schedule events 20, generate or modify webpages 200 for the events 20, determine the number of users for the events 20, and/or adjust the system properties and the content delivery based on the number of users and the system resources.

The user device 10 may correspond to any computing device, such as a desktop workstation, a laptop workstation, or a mobile device (e.g., a smartphone). Each user device 10 may include computing resources 18 (e.g., data processing hardware) and/or storage resources 16 (e.g., memory hardware). The data processing hardware 18 may execute a graphical user interface (GUI) 19 for display on a screen 14 in communication with the data processing hardware 18. The GUI 19 may be provided by the content publishing application 110 or by a web browser running on the user device 10. Some or all of the content publishing application 110 and/or the event scheduler 150 may execute on the user device 10. For example, a portion of the content publishing application 110 may execute on the remote system 140 while a different portion of the content publishing application 110 executes on the user device 10. In other examples, the content publishing application 110 executes entirely on the remote system or entirely on the user device 10.

The GUI 19 may include various graphical elements, such as icons, buttons, menus, toolbars, panels, or windows, that represent various functions, features, or data of the content publishing application 110 or the events 20. Users 12 may manipulate the graphical elements using input devices, such as a mouse, a keyboard, a touch screen, a microphone, or a stylus, to perform various tasks or operations related to the events 20.

In some implementations, the event scheduler 150 receives a request 22 to schedule an event 20 from a user device 10. The request 22 may include a number of attendees invited to the event 20. For example, the user 12 may manually input the number of attendees when scheduling the event 20. Alternatively, the event scheduler 150 may automatically determine the number of attendees based on various factors. For instance, the event scheduler 150 may use attendance of past events of a similar nature to estimate the number of attendees. The event scheduler 150 may integrate with calendar applications to check the availability of potential attendees and automatically generate an attendee list. Optionally, the event scheduler 150 determines or estimates or predicts the number of attendees based on other information associated with or provided by the user 12. For example, the user 12 may select or be associated with a department or organization. Based on the associated department or organization, the event scheduler 150 may predict the number of attendees (e.g., based on the number of individuals in the associated department).

The event scheduler 150 optionally determines that the number of attendees satisfies a threshold 152. The threshold 152 may be a predefined or dynamic value that indicates the minimum or maximum number of users that triggers a surge event 20S. A surge event 20S may be an event that benefits from special handling by the event scheduler 150 to prevent system overload or crash or to otherwise prevent negative consequences for users 12 or the system 100 based on the computational load caused by the event 20. The threshold 152 may be based on various factors, such as the amount of computing resources available to the remote system 140, the number of other scheduled events 20, the type or category of the event, and/or user input or feedback. In some examples, when the number of attendees exceeds the threshold 152, the event 20 is classified as a surge event 20S and when the number of attendees fails to exceed the threshold 152, the event 20 is not classified as a surge event 20S.

In some implementations, the user 12 may indicate a desire or request to make the event 20 a surge event 20S. For example, the request 22 may include an indication that the event 20 should be a surge event 20S. Optionally, the user 12 is able to request that an event 20 that does not satisfy the threshold 152 (i.e., is not a surge event 20S based on the threshold 152) be considered a surge event 20S, while the user 12 is not able to request that a surge event 20 (i.e., an event 20 that does satisfy the threshold 152) be considered a non-surge event 20. In this way, the event scheduler 150 allows the user 12 some control without allowing the user 12 to overload the resources of the remote system 140.

Based on determining that the number of attendees satisfies the threshold 152 (e.g., the number of attendees exceeds a value), the event scheduler 150 may generate a first webpage 200 for hosting the event 20. Webpages 200 often consume a lot of resources by loading dynamic data, such as images, videos, and interactive elements when the webpage 200 is loaded. For example, each visit to a webpage 200 can generate numerous server calls 210 to fetch this data, which can significantly increase the load on the server 140. Other resources consumed include bandwidth for data transfer, memory for storing dynamic content, and processing power for rendering complex elements. These factors can lead to slower performance and higher operational costs, especially during high-traffic events 20S.

In some examples, the event scheduler 150 generates or builds the first webpage 200 at least in part via the user 12 interacting with the content publishing application 110. For example, via the GUI 19, the user 12 selects the content that is included in the webpage 200 (e.g., using drag and drop interactions). The content may include text, images, audio, video, or other multimedia elements that convey the information or message of the event 20.

In this example, the event scheduler 150, based on determining that the number attendees satisfies the threshold 152 (e.g., the number of attendees is less than the threshold 152), configures the first webpage 200 to generate a default or standard number of server calls 210 to the remote system 140. That is, when the webpage 200 is loaded or executed by a user device 10, the webpage 200 will perform a default number of server calls 210 (e.g., to load dynamic data for display at the GUI 19). A server call 210 may be a request or a response that is sent or received by the remote system 140 via the network 112. For example, a server call 210 requests that the remote system 140 fetch and provide information to a user device 10 viewing the first webpage 200. Other server calls 210 may determine whether the user 12 has access to certain information. The information may be retrieved from, for example, data store 148 or from a third-party server. The webpage 200 may be a regular event page that is suitable for normal (i.e., non-surge) events 20. For example, the webpage 200 has a full menu bar and standard processing requirements.

Continuing this example, the event scheduler 150 may also receive a second request 22 to schedule a second event 20 from a user device 10. The second request 22 may include a second number of attendees invited to the second event 20 that is different (e.g., greater) than the number of attendees for the previous event 20. In this example, the event scheduler 150 determines that the second number of attendees fails to satisfy the threshold 152. For example, the event scheduler 150 determines that the number of attendees exceeds (or equals) the threshold 152.

Based on determining that the second number of attendees fails to satisfy the threshold, the event scheduler 150, in some implementations, determines that the second event 20 should be classified as a surge event 20S. In response, the event scheduler 150 may generate a second webpage 200 for hosting the second event 20S. The second webpage 200, when visited by a user device 10, may generate a second number of server calls 210 to the remote system 140. The second number of server calls 210 may be relatively low compared to the first number of server calls 210 generated by the first webpage 200 in order to reduce the computational and bandwidth requirements on the remote system 140. That is, the second webpage 200 may be a dedicated event page that is optimized for high-traffic events 20S. For example, the second webpage 200 has a reduced menu bar and/or minimal processing requirements, which significantly reduces the load on the remote system 140.

The second webpage 200 may include content that is similar to the content of the first webpage 200, but with less detail or resolution. Information automatically loaded (i.e., via server calls 210) for the first webpage 200 may still be available to users 12 of the second webpage 200, but the users 12 of the second webpage 200 may need to explicitly request (e.g., via clicking a hyperlink or the like) the information instead of the information automatically loading.

Thus, the event scheduler 150 may generate new webpages 200 or adjust existing webpages 200 based on the number of attendees. For instance, if the number of attendees satisfies the threshold 152, the event scheduler 150 generates a webpage 200 that includes a full menu bar and dynamic content, resulting in a higher number of server calls 210. Conversely, if the number of attendees does not satisfy the threshold 152, the event scheduler generates a webpage 200 with a reduced menu bar and minimal dynamic content, resulting in fewer server calls 210. The event scheduler 150 may also adjust existing webpages 200 by altering menu bars or embedding video streams to reduce server calls 210 or implementing lazy loading techniques to optimize server performance.

In some examples, the event scheduler 150 generates a link 220 (e.g., a hyperlink) that directs users 12 to the corresponding webpage 200. In the example above, the event scheduler 150 generates a first link 220 that directs users 12 to the first webpage 200 and a second link 220 that directs users 12 to the second webpage 200. The event scheduler 150 may distribute the links 220 to the attendees invited to the event 20. The distribution may be done via email, text message, social media, or any other communication channel. By accessing the webpage 200 via a direct link 220, the users 12 may bypass a standard or default webpage (e.g., an event page, a company portal page, etc.) that is usually loaded to access events 20. These pages may not be optimized for high amounts of traffic, and thus may crash or become unresponsive, which not only impacts the attendees of the event 20 but also other users 12 of the webpage.

The event scheduler 150 may differentiate between normal events 20 and surge events 20S based on the number of users 12. For example, the event scheduler 150 monitors the number of users 12 that access the first webpage 200 or the second webpage 200 via the network 112. The event scheduler 150 may compare the number of users 12 with the threshold 152 and determine whether the event is a normal event 20 or a surge event 20S. When the event is a normal event 20, the event scheduler 150 may continue to provide the content and the functionality of the first webpage 200 (i.e., the full webpage 200) to the user device 10. When the event is a surge event 20S, the event scheduler 150 may automatically switch to a lightweight menu bar and/or other optimizations to handle the increased load. The lightweight menu bar may have fewer or simpler options than the full menu bar and may load less dynamic data from the remote system 140. The optimizations may include, but are not limited to, lazy loading content, embedding video streams from external providers, caching data, compressing data, or reducing the frequency or the size of the server calls 210.

In some implementations, the event scheduler 150 dynamically adjusts the system properties and/or the content delivery based on current system resources and other scheduled events 20. For example, the event scheduler 150 determines the amount of computing resources available to the remote system 140, such as the processing power, the memory capacity, the bandwidth, or the storage space. When resources are plentiful, the threshold 152 may be increased. Conversely, when resources are limited, the event scheduler 150 may decrease the threshold 152.

The event scheduler 150 may determine the number and the type of other scheduled events 20 that may affect the system performance. The event scheduler 150 may adjust the threshold 152 and/or the webpages 200 based on the resources required to host other events 20 happening at or near the same time. For example, the event scheduler 150 may lower the threshold 152, reduce the menu bar, simplify the content, or minimize the server calls 210 if an amount and/or size of other scheduled events 20 are high. Alternatively, the event scheduler 150 may raise the threshold 152, increase the menu bar, enrich the content, or maximize the server calls 210 when there are few other scheduled events 20.

In some examples, the event scheduler 150 provides user experience enhancements to the user device 10. The user experience enhancements may include, but are not limited to, providing direct links 220 to the webpages 200 (e.g., event pages), redirecting users 12 to the appropriate webpages 200, generating pop-up notifications, offering user choices, or providing feedback or guidance. For example, the event scheduler 150 provides a direct link 220 for a webpage 200 to the user device 10, so that the user 12 does not have to navigate through the employee center or other pages to join the event 20. Additionally or alternatively, the event scheduler 150 redirects the user 12 to a webpage 200 when the user 12 logs into the employee center or another page during a high-traffic event 20S. That is, when a high-traffic event 20S is in progress, navigation to the default employee center (or other event page) may automatically redirect the user 12 to the webpage 200 configured for high traffic. For example, the event scheduler 150 determines that a user 12 has accessed a particular page within a scheduled timeframe of a surge event 20S and, in response, automatically directs the user 12 to the lightweight webpage 200 associated with the surge event 20S and/or notifies the user 12 of the availability of the lightweight webpage 200.

In some implementations, the event scheduler 150, in response to a user interaction indicating a user 12 interacted with an event page (e.g., by clicking on a hyperlink linking to the event page or by navigating to the event page from a portal page or home page or the like), the event scheduler 150, in real time, determines whether the event 20 the user 12 is attempting to access is a surge event 20S. When the event is a surge event 20S, the event scheduler 150 loads a performance menu bar (e.g., a reduced menu bar), loads minimum widgets, etc. to reduce computational load. When the event is not a surge event 20S, the event scheduler 150 instead loads the page normally (e.g., with a full menu bar, full widgets, etc.). That is, in some implementations, the event scheduler 150 modifies or adjusts the webpage 200 automatically based on real time identification of a surge event 20S.

Optionally, the event scheduler 150 may change the classification of an event 20 from non-surge to surge based on, for example, available resources or the number of attendees that are attending the event 20. For example, the event scheduler 150 may originally schedule an event 20 as a non-surge event, but during the event, either a decrease in available resources or a greater than expected number of attendees causes the event scheduler 150 to reclassify the event as a surge event 20S. In this example, the event scheduler 150 may direct further attendees that join to a reduced or lightweight webpage 200. In some examples, the event scheduler 150 may reload webpages 200 for current attendees to allow for the loading of the lightweight webpage 200.

The event scheduler 150, in some examples, generates a notification (e.g., a pop-up notification) to inform the user 12 of the redirection or to ask the user for confirmation of the redirection. For example, the event scheduler 150 offers the user 12 (e.g., via a notification displayed on the GUI 19) a choice to go to the webpage 200 for the event 20S or to continue with their regular tasks, depending on the user's interest or priority. The event scheduler 150 may provide feedback or guidance to the user 12 regarding the event 20S, such as the event name, the event type, the event time, the event duration, the event content, the event status, or the event actions.

Optionally, the event scheduler 150 provides one or more configuration options for content administrators or creators to select different menu bars for surge events 20S. The configuration options may allow the content administrators to customize the menu bar based on the organizational needs or the user preferences. The content administrators may select from a predefined set of menu bars or create their own menu bars. In some examples, the content administrators specify the criteria or the conditions for applying the selected menu bars to the surge events 20S. The event scheduler 150 may apply the selected menu bars to the surge events 20S based at least in part on the configuration options. The configuration options may enhance the flexibility and the user control of the content publishing application 110.

In some examples, the surge events 20S are classified or tiered into different levels. Each tier or level may be associated with a different amount of reduction in server calls 210 or other resource optimizations. For example, a non-surge event may be mapped to or be associated with a default or normal webpage 200 that loads 50 widgets. A first-tier surge event 20S may be associated with a webpage 200 that instead loads 25 widgets. A second-tier surge event 20S may be associated with a webpage 200 that instead only loads 5 widgets. Each tier or class, in some implementations, is associated with a different threshold 152. For example, an event 20 with 500 to 1,000 attendees may be a first-tier surge event 20S while an event 20 with over 1,000 attendees may be a second-tier surge event 20S. The event scheduler 150 may classify events 20 into any number of tiers associated with any number of different thresholds 152.

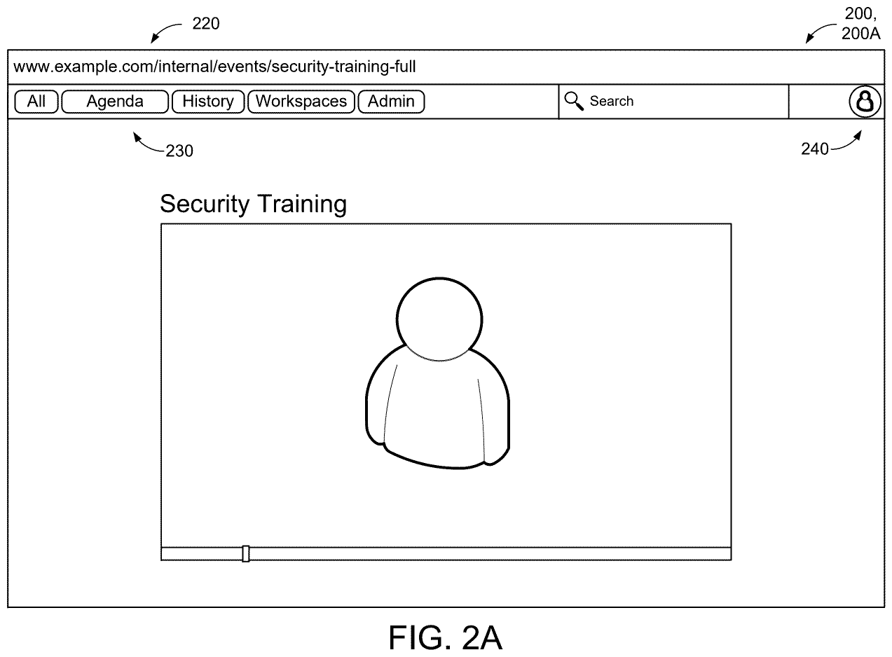

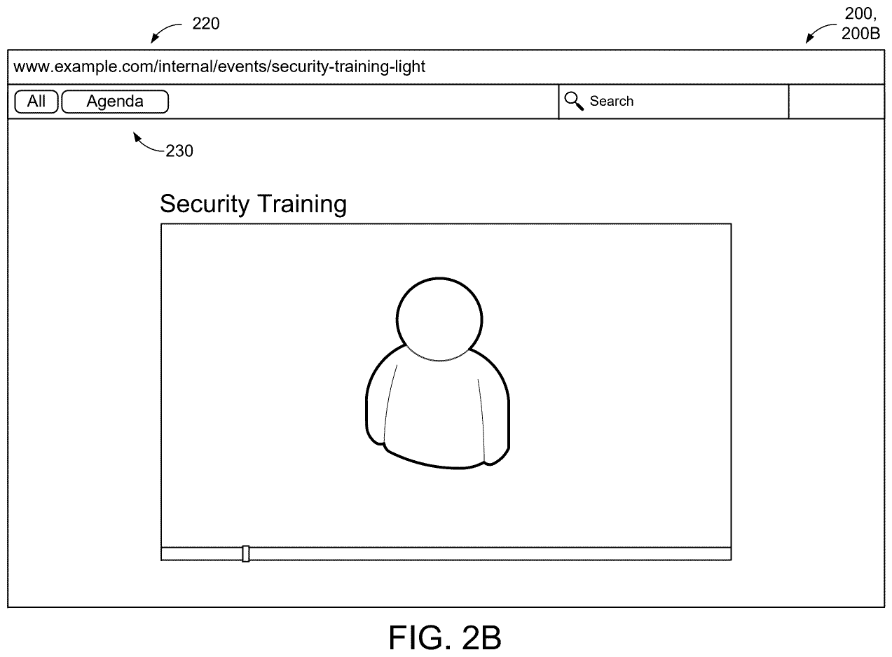

FIG. 2A is a schematic view of an example webpage 200, 200A for hosting a non-surge event 20. The webpage 200 includes a link 220 at the top of the webpage 200 that directs users 12 to the webpage 200. Below the link 220 is a menu bar 230 that has five interactable buttons that provide various functions or features related to the event 20, such as viewing the event agenda, accessing related documents, submitting feedback, or joining a chat room. To the right of the menu bar 230 is a widget 240 that may be interacted with to display additional information or content, such as a user profile. In this example, the webpage 200 has an embedded video titled “Security Training” that shows the content of the event 20. The menu bar 230 may generate several server calls 210 in order to fetch data and to determine whether the user 12 has access to the information governed by each button. Similarly, the widget 240 may call the server 140 to preload data or determine access rights. The webpage 200 may be a regular event page that is suitable for normal (i.e., non-surge) events 20. For example, the webpage 200 has a full menu bar 230 and standard processing requirements.

FIG. 2B is a schematic view of an example webpage 200, 200B for hosting a surge event 20S. The webpage 200 is similar to the webpage 200 of FIG. 2A, but in this example, it is a lightweight webpage 200 designed for high-traffic events 20S. In this example, the menu bar 230 is reduced to only having two buttons that may provide essential functions or features related to the event 20S, such as viewing the event agenda. There are no widgets 240 on the webpage 200. In some examples, the buttons of the menu bar 230 may not preload data but instead wait to fetch data until a user 12 interacts with the buttons. The lightweight webpage 200 may make other optimizations, such as with the video embedding and playback. For example, the video may be embedded from an external provider that can handle the high demand for streaming, or the video may be played at a lower resolution or quality to save bandwidth. The lightweight webpage 200 may be a dedicated event page that is optimized for high-traffic events 20S. For example, the webpage 200 has a reduced menu bar 230 and minimal processing requirements, which significantly reduces the load on the remote system 140.

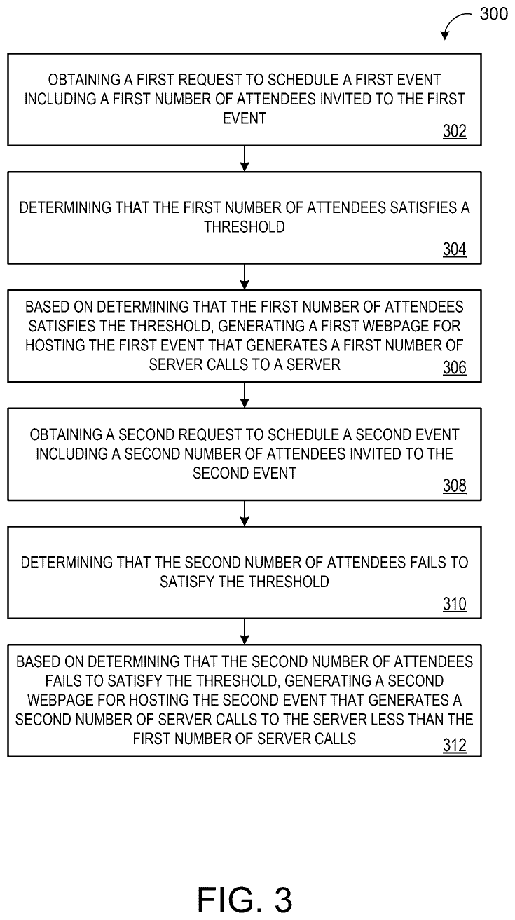

FIG. 3 is a flowchart of an exemplary arrangement of operations for a method 300 of configuring events 20. The method 300, at step 302, includes obtaining a first request 22 to schedule a first event 20, The first request 22 includes a first number of attendees invited to the first event 20. At step 304, the method 300 includes determining that the first number of attendees satisfies a threshold 152. At step 306, the method 300 includes, based on determining that the first number of attendees satisfies the threshold 152, generating a first webpage 200 for hosting the first event 20. The first webpage 200, when visited, generates a first number of server calls 210 to a server 140.

At step 308, the method 300 includes obtaining a second request 22 to schedule a second event 20. The second request 22 includes a second number of attendees invited to the second event 20. The method 300, at step 310, includes determining that the second number of attendees fails to satisfy the threshold 152. At step 312, based on determining that the second number of attendees fails to satisfy the threshold 152, the method 300 includes generating a second webpage 200 for hosting the second event 20. The second webpage 200, when visited, generates a second number of server calls 210 to the server 140 that is less than the first number of server calls 210.

Thus, the event scheduler 150 may differentiate between normal events 20 and surge events 20S based on, for example the number of attendees (e.g., a predicted number of attendees or an actual number of attendees). This differentiation allows the event scheduler 150 to dynamically adjust the system properties and the content delivery based on the current resources and user activity, ensuring a positive user experience even during high-traffic events 20S. Moreover, this differentiation reduces the risk of system crashes or slow performance that may occur when many users 12 access a webpage 200 that is not optimized for high-traffic events 20S.

Accordingly, when the event is a normal event 20, the event scheduler 150 may continue to provide the content and the functionality of the first webpage 200 (i.e., the full webpage 200) to the user device 10. When the event is a surge event 20S, the event scheduler 150 may automatically switch to a lightweight menu bar and/or other optimizations to handle the increased load. The lightweight menu bar may have fewer or simpler options than the full menu bar and may load less dynamic data from the remote system 140. The optimizations may include, but are not limited to, lazy loading content, embedding video streams from external providers, caching data, compressing data, or reducing the frequency or the size of the server calls 210. These optimizations reduce the number of server calls 210 and the amount of data transferred between the user device 10 and the remote system 140, thereby saving bandwidth, memory, and processing power. These optimizations also enhance the efficiency and stability of the content publishing platform by minimizing the resource wastage and the operational costs.

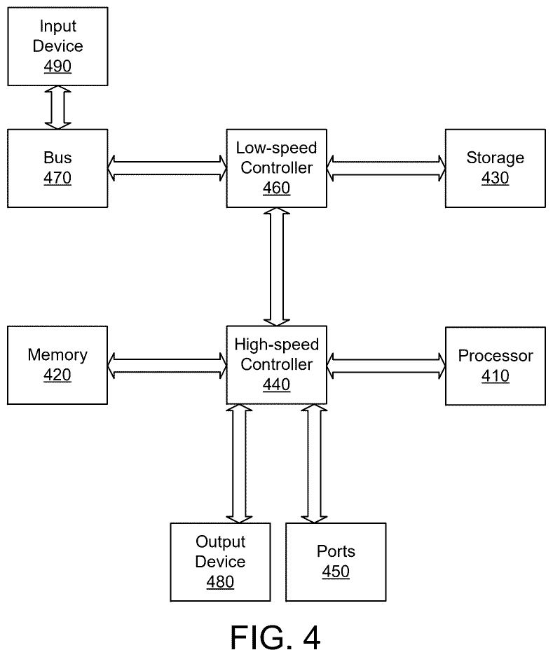

FIG. 4 is a schematic view of an example computing device 400 that may be used to implement the systems and methods described in this document. The computing device 400 is intended to represent various forms of digital computers, such as laptops, desktops, workstations, tablets, smartphones, servers, blade servers, mainframes, and other appropriate computers. The components shown here, their connections and relationships, and their functions, are meant to be illustrative only, and are not meant to limit implementations described and/or claimed in this document.

The computing device 400 includes a processor 410, memory 420, a storage device 430, a high-speed interface/controller 440 connecting to the memory 420 and high-speed expansion ports 450, and a low-speed interface/controller 460 connecting to a low-speed bus 470 and a storage device 430. Each of the components 410, 420, 430, 440, 450, and 460, are interconnected using various busses, and may be mounted on a common motherboard or in other manners as appropriate. The processor 410 can execute instructions for performing operations within the computing device 400, including instructions stored in the memory 420 or on the storage device 430 to display graphical information for a graphical user interface (GUI) on an external input/output device, such as display 480 coupled to high-speed interface 440. In other implementations, multiple processors and/or multiple buses may be used, as appropriate, along with multiple memories and types of memory. Also, multiple computing devices 400 may be connected, with each device providing portions of the necessary operations (e.g., as a server cluster, a group of blade servers, or a multi-processor system).

The memory 420 stores information within the computing device 400. The memory 420 may be a non-transitory computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 430 is capable of providing mass storage for the computing device 400. In some implementations, the storage device 430 is a non-transitory computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is embodied in a non-transitory information carrier. The computer program product contains instructions that, when executed, perform one or more methods, such as those described above. The information carrier is a non-transitory computer-readable medium, such as the memory 420, the storage device 430, or memory on processor 410.

The high-speed controller 440 manages bandwidth-intensive operations for the computing device 400, while the low-speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port or input device 490. The low-speed expansion port 490, which may include various communication ports (e.g., USB, Bluetooth, Ethernet, wireless Ethernet), may be coupled to one or more input/output devices, such as a keyboard, a pointing device, a microphone, a touch screen, a scanner, or a networking device such as a switch or router, e.g., through a network adapter.

The computing device 400 may be implemented in a number of different forms, as shown in the figure. For example, it may be implemented as a standard server or multiple times in a group of such servers, as a laptop computer, or as part of a rack server system.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “non-transitory computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory computer-readable medium that receives machine instructions as a non-transitory computer-readable signal. The term “non-transitory computer-readable signal” refers to any signal used to provide machine instructions and/or data to a programmable processor.

A software application (i.e., a software resource) may refer to computer software that instructs a computing device to perform a specific function or set of functions. A software application may be executed by a processor, a virtual machine, a web browser, or another software component on the computing device. In some examples, a software application may be referred to as an “application,” an “app,” a “program,” or a “service.” Example applications include, but are not limited to, system diagnostic applications, system management applications, system maintenance applications, word processing applications, spreadsheet applications, messaging applications, media streaming applications, social networking applications, gaming applications, e-commerce applications, cloud computing applications, artificial intelligence applications, and blockchain applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer.

Generally, a processor will receive instructions and data from a non-volatile memory or a volatile memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Non-transitory computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method comprising:
obtaining a first request to schedule a first event, the first request comprising a first number of attendees invited to the first event;
determining that the first number of attendees satisfies a threshold;
based on determining that the first number of attendees satisfies the threshold, generating a first webpage for hosting the first event, the first webpage, when visited, generating a first number of server calls to a server;
obtaining a second request to schedule a second event, the second request comprising a second number of attendees invited to the second event;
determining that the second number of attendees fails to satisfy the threshold; and
based on determining that the second number of attendees fails to satisfy the threshold, generating a second webpage for hosting the second event, the second webpage, when visited, generating a second number of server calls to the server, the second number of server calls less than the first number of server calls.

2. The method of claim 1, wherein the threshold is static.

3. The method of claim 1, further comprising:
determining an amount of computing resources available to the server; and
adjusting the threshold based on the determined amount of computing resources available to the server.

4. The method of claim 1, wherein:
the first webpage comprises a first menu bar that loads a first amount of dynamic data from the server; and
the second webpage comprises a second menu bar that loads a second amount of dynamic data from the server, and wherein the second amount of dynamic data is less than the first amount of dynamic data.

5. The method of claim 1, wherein:
the first webpage does not use lazy loading; and
the second webpage uses lazy loading.

6. The method of claim 1, further comprising:
generating a first link that directs users to the first webpage;
generating a second link that directs attendees to the second webpage; and
distributing the first link and the second link to the attendees invited to the first event and the second event.

7. The method of claim 1, further comprising:
obtaining a third request to visit the first webpage;
determining that a user associated with the third request is associated with the second event; and
prior to loading the first webpage, directing the user to the second webpage.

8. The method of claim 7, wherein directing the user to the second webpage comprises generating a pop-up notification.

9. The method of claim 1, wherein:
determining that the first number of attendees satisfies the threshold comprises determining that the first number of attendees is less than the threshold; and
determining that the second number of attendees fails to satisfy the threshold comprises determining that the second number of attendees is greater than or equal to the threshold.

10. The method of claim 1, wherein the first webpage and the second webpage are each associated with an employee portal.

11. The method of claim 1, wherein generating the second webpage comprises embedding a video stream to reduce server calls to the server.

12. A system comprising:
data processing hardware; and
memory hardware in communication with the data processing hardware, the memory hardware storing instructions that when executed on the data processing hardware cause the data processing hardware to perform operations comprising:
obtaining a first request to schedule a first event, the first request comprising a first number of attendees invited to the first event;
determining that the first number of attendees satisfies a threshold;
based on determining that the first number of attendees satisfies the threshold, generating a first webpage for hosting the first event, the first webpage, when visited, generating a first number of server calls to a server;
obtaining a second request to schedule a second event, the second request comprising a second number of attendees invited to the second event;
determining that the second number of attendees fails to satisfy the threshold; and
based on determining that the second number of attendees fails to satisfy the threshold, generating a second webpage for hosting the second event, the second webpage, when visited, generating a second number of server calls to the server, the second number of server calls less than the first number of server calls.

13. The system of claim 12, wherein the threshold is static.

14. The system of claim 12, further comprising:
determining an amount of computing resources available to the server; and
adjusting the threshold based on the determined amount of computing resources available to the server.

15. The system of claim 12, wherein:
the first webpage comprises a first menu bar that loads a first amount of dynamic data from the server; and
the second webpage comprises a second menu bar that loads a second amount of dynamic data from the server, and wherein the second amount of dynamic data is less than the first amount of dynamic data.

16. The system of claim 12, wherein:
the first webpage does not use lazy loading; and
the second webpage uses lazy loading.

17. The system of claim 12, further comprising:
generating a first link that directs users to the first webpage;
generating a second link that directs attendees to the second webpage; and
distributing the first link and the second link to the attendees invited to the first event and the second event.

18. The system of claim 12, further comprising:
obtaining a third request to visit the first webpage;
determining that a user associated with the third request is associated with the second event; and
prior to loading the first webpage, directing the user to the second webpage.

19. The system of claim 18, wherein directing the user to the second webpage comprises generating a pop-up notification.

20. A computer-readable medium having instructions that, when executed by data processing hardware, causes the data processing hardware to perform operations comprising:
obtaining a first request to schedule a first event, the first request comprising a first number of attendees invited to the first event;
determining that the first number of attendees satisfies a threshold;
based on determining that the first number of attendees satisfies the threshold, generating a first webpage for hosting the first event, the first webpage, when visited, generating a first number of server calls to a server;
obtaining a second request to schedule a second event, the second request comprising a second number of attendees invited to the second event;
determining that the second number of attendees fails to satisfy the threshold; and
based on determining that the second number of attendees fails to satisfy the threshold, generating a second webpage for hosting the second event, the second webpage, when visited, generating a second number of server calls to the server, the second number of server calls less than the first number of server calls.
